(19) United States
(12) Patent Application Publication
(10) Pub. No.: US 2022/0396430 A1
(43) Pub. Date: Dec. 15, 2022

(54) POWERED CARTON MAGAZINE

(71) Applicant: BARTELT PACKAGING LLC, Covington, KY (US)

(72) Inventors: Adam FREED, Sarasota, FL (US); Huy DO, Valrico, FL (US)

(21) Appl. No.: 17/343,935

(22) Filed: Jun. 10, 2021

(51) Int. Cl. B65G 43/08; B65G 47/44; B65G 47/84

(52) U.S. Cl. CPC B65G 43/08; B65G 47/44; B65G 47/846; B65G 2203/0241

(57) ABSTRACT

A powered carton magazine assembly includes a lateral conveyor configured for conveying a plurality of upright folded/flat cartons in a feed direction, the lateral conveyor having a load end and an outfeed end. A picking station is located at the outfeed end of the lateral conveyor, the picking station including a downwardly angled feed path and a pick location at a lower portion of the feed path. A gating mechanism is provided at the outfeed end of the lateral conveyor for selectively controlling delivery of cartons from the lateral conveyor into the feed path. The gating mechanism may include a roller.

### TECHNICAL FIELD

This application relates generally to belt driven carton magazines and, more specifically, to a high capacity carton magazine with low backpressure.

### BACKGROUND

In the packaging of items, belt drive carton magazines that feed folded/flat cartons to a pick station are known. Referring to FIG. 1, an exemplary belt driven carton magazine 10 includes a belt conveyor 12 along which upright folded/flat cartons 14 are conveyed in a direction 16 toward a picking station 18 that includes a frame 20 that defines an opening through which a carton can be picked by a picking device 22 (e.g., a rotary carton feeder assembly). A rear guide 12a of the belt conveyor maintains the cartons 14 at the load side upright, and as the cartons approach the picking station 16 they fall toward and into the picking station chute. The collective force 24 of the cartons against the frame 20 creates a backpressure on the lead carton that is adjacent the pick opening. This backpressure can, particularly in the case of larger carton sizes, become excessive and cause distortion of the carton (e.g., bulging, warping etc. of the carton adjacent the frame opening), making it difficult for the picking device 20 to properly pick and place the cartons.

Accordingly, it would be desirable to provide a carton magazine that provides the ability to eliminate excessive backpressure on the cartons waiting to be picked.

### SUMMARY

In one aspect, a powered carton magazine assembly includes a lateral conveyor configured for conveying a plurality of upright folded/flat cartons in a feed direction, the lateral conveyor having a load end and an outfeed end. A picking station is located at the outfeed end of the lateral conveyor, the picking station including a picking station chute and a frame at a lower portion of the picking station chute, wherein the frame defines an opening through which cartons can be individually picked. A gating mechanism is provided at the outfeed end of the lateral conveyor for selective delivery of cartons from the lateral conveyor down into the picking station chute

In another aspect, a powered carton magazine assembly includes a lateral conveyor configured for conveying a plurality of upright folded/flat cartons in a feed direction, the lateral conveyor having a load end and an outfeed end. A picking station is located at the outfeed end of the lateral conveyor, the picking station including a downwardly angled feed path and a frame at a lower portion of the feed path, wherein the frame defines an opening through which cartons can be picked. A gating mechanism is provided at the outfeed end of the lateral conveyor for selectively controlling delivery of cartons from the lateral conveyor into the feed path.

In yet another aspect, a powered carton magazine assembly includes a lateral conveyor configured for conveying a plurality of upright folded/flat cartons in a feed direction, the lateral conveyor having a load end and an outfeed end. A picking station is located at the outfeed end of the lateral conveyor, the picking station including a downwardly angled feed path and a pick location at a lower portion of the feed path. A gating mechanism is provided at the outfeed end of the lateral conveyor for selectively controlling delivery of cartons from the lateral conveyor into the feed path.

In a further aspect, a method of operating a powered carton magazine assembly involves conveying a plurality of upright folded/flat cartons in a feed direction along a lateral feed path toward a picking station, wherein the picking station including a downwardly angled feed path and a pick location at a lower portion of the feed path; and, controlling a gating mechanism for selectively controlling delivery of cartons from the lateral feed path into the downwardly angled feed path. In one implementation, the gating mechanism is a roller that controlled by rotation to feed from the lateral feed path to the downwardly angled feed path. In one implementation, the gating mechanism is controlled based upon sensing of cartons in the downwardly angled feed path.

The details of one or more embodiments are set forth in the accompanying drawings and the description below. Other features, items, and advantages will be apparent from the description and drawings, and from the claims.

### BRIEF DESCRIPTION OF THE DRAWINGS

FIG. 1 is a schematic depiction of a prior art powered carton magazine assembly;

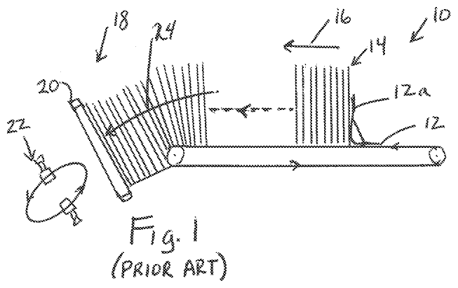

FIG. 2 is a perspective view of one embodiment of a powered carton magazine assembly;

FIG. 3 is a side elevation view of the powered carton magazine;

FIG. 4 is a partial perspective of a rear portion of the powered carton magazine;

FIG. 5 is a partial perspective of a forward portion of the powered carton magazine;

FIG. 6 is a partial side elevation of the forward portion of the powered carton magazine, with some components removed;

FIG. 7 is another a partial perspective of a forward portion of the powered carton magazine, with some components removed;

FIG. 8 is another a partial perspective of a forward portion of the powered carton magazine;

FIG. 9 is another a partial perspective of a forward portion of the powered carton magazine, with some components removed;

FIG. 10 is a perspective view of another embodiment of a powered carton magazine assembly; and

FIG. 11 is a partial perspective of a forward portion of the embodiment of FIG. 10.

### DETAILED DESCRIPTION

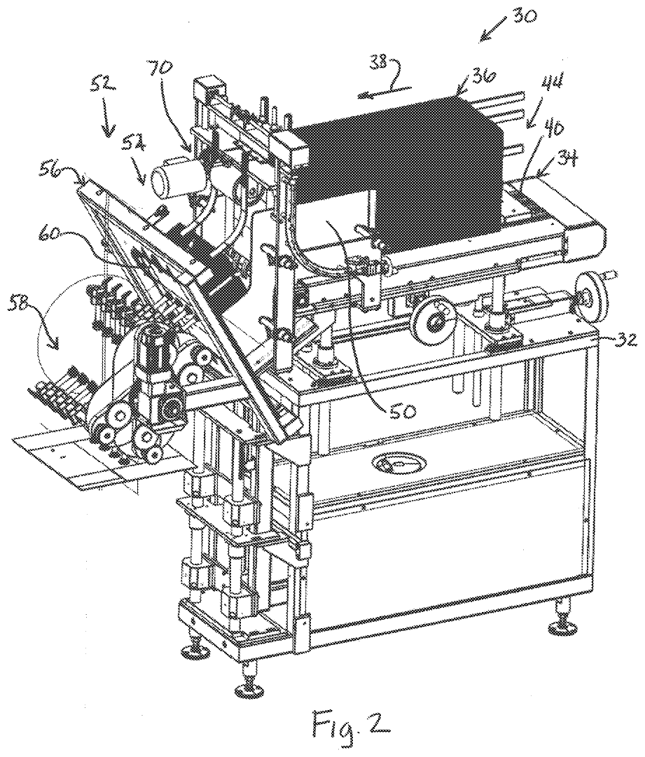

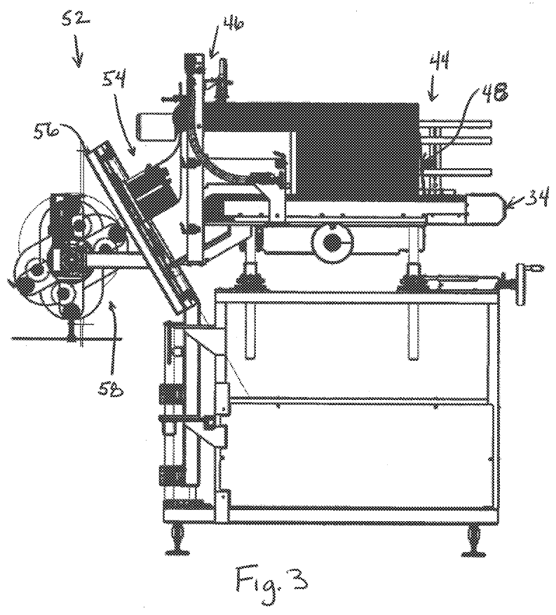

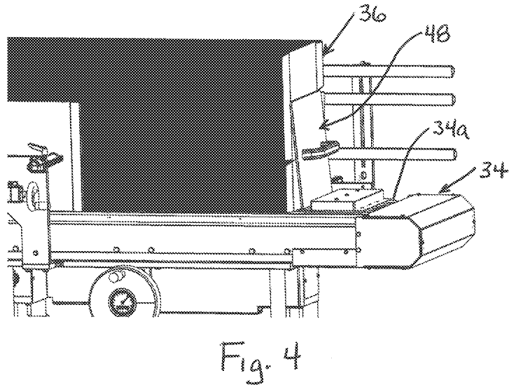

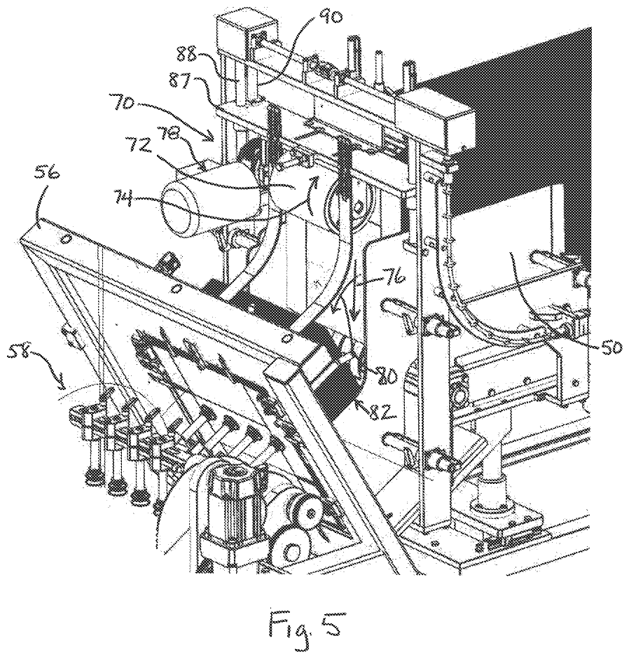

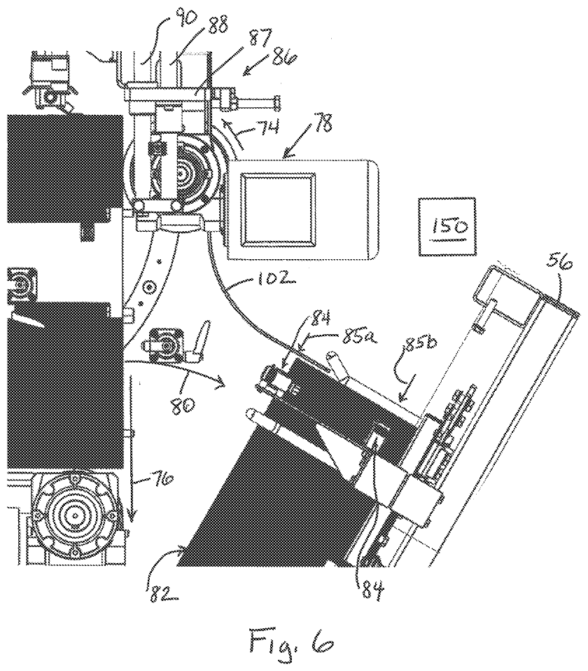

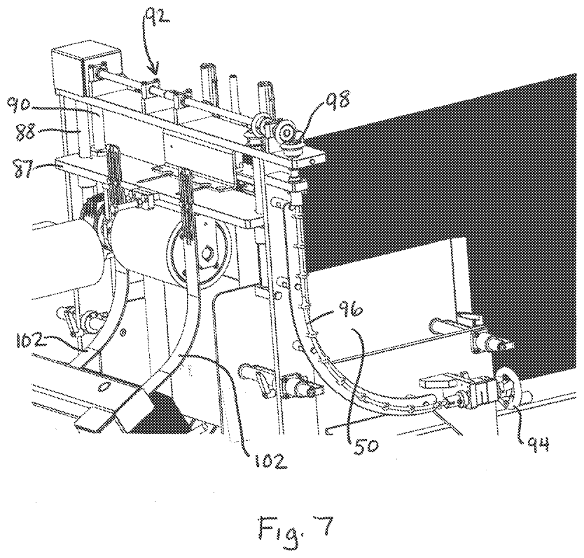

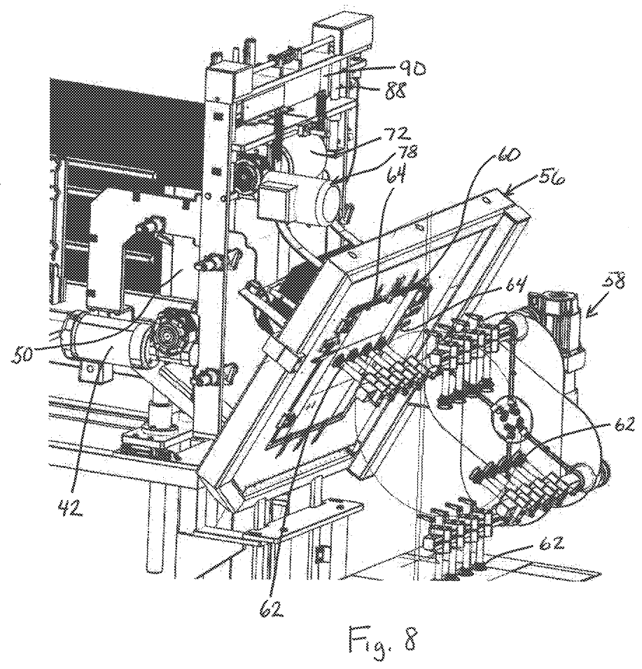

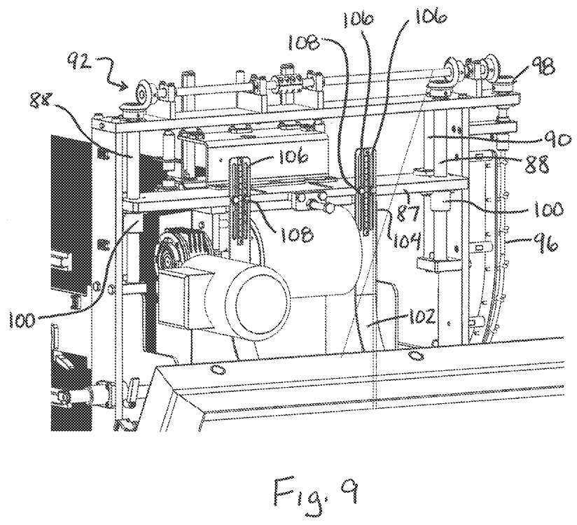

Referring FIGS. 2-9, a powered carton magazine assembly 30 includes a support frame 32 carrying a lateral conveyor 34 that is configured for conveying a plurality of upright folded/flat cartons 36 in a feed direction 38. Here, the lateral conveyor is formed by a looped belt conveyor 40 (with one or more belt segments) with an associated drive motor 42, and the later conveyor has a load end 44 and an outfeed end 46. A rear guide 48 maintains the upright configuration of the cartons 36. Upright side plates 50 are located along an end section of the lateral conveyor, and the lateral position of each side plate 50 relative to the sides of the lateral conveyor is adjustable for centering of different carton sizes.

A picking station 52 is located at the outfeed end of the lateral conveyor 32. Here, the picking station 52 includes a picking station chute 54, a pick frame 56 at a lower portion of the picking station chute, and a rotary picking device 58. The frame 56 defines an opening 60 through which cartons can be individually picked by suction grippers 62 of the rotary picking device 58. The cartons 36 are restrained from falling through the opening 60 by retaining brackets (e.g., 64) that extend inward beyond the perimeter of the opening, with the retaining brackets positioned and configured to allow a carton to be pulled through the opening and past the retaining brackets when sufficient pulling force on the carton is exerted by the rotary picking device 58. The size of the frame opening 60 may be adjustable to accommodate various carton sizes. The chute 54 provides a downwardly angled carton feed path toward the pick location of the picking station 52.

In order to prevent cartons 36 from freely falling into the chute 54, a gating mechanism 70 is provided at the outfeed end of the lateral conveyor. The gating mechanism 70 acts as a stop for the cartons and can be operated for selective delivery of cartons from the lateral conveyor down into the picking station chute 54. Here, the gating mechanism 70 is formed by a rotatable roller 72 configured such that rotation of the roller in a direction 74 will move a carton blank 36 at the outfeed end of the lateral conveyor down, per arrow 76, into the picking station chute. The roller 72 may, for example, be a rubber coated roller, with the rubber material providing a gripping/frictional engagement with the leading face of the lead carton on the lateral conveyor. A drive 78 (e.g., motor and gearbox) is provided for controlling the roller rotation. Once the carton blank enters the chute the carton blank pivots downward, per arrow 80, toward and against the carton stack 82 already in the chute.

Notably, the gating mechanism 70 absorbs the force exerted by or on the cartons in the feed direction 38, thus preventing any of that force from being applied on the carton stack 82 in the chute 54. The force applied on the carton that is adjacent the pick frame opening is limited to that of the weight of the following cartons in the carton stack 82. The gating mechanism 70 may be controlled to set the stack level in the chute as desired. For example, in one implementation, a gating mechanism control system includes at least one sensor 84 (e.g. photo eye, mechanical switch triggered by carton contact or camera) for detecting cartons in the picking station chute 54 and a controller 150 associated with the sensor 84 and the gating mechanism 70, where the controller 150 is configured to control the gating mechanism based at least in part upon an output from the sensor. The controller 150 may configured, in connection with the sensor(s) 84, to control the gating mechanism so as to prevent a level of cartons in the picking station chute from exceeding a set high level 85a and/or to prevent the level of cartons in the picking station chute from falling below a set low level 86a. Moreover, the controller 150 may be configured such that, if the level of the cartons in the picking station chute does fall below a set low level, the controller 150 triggers an alarm (e.g., visual and/or audio and/or electronic message).

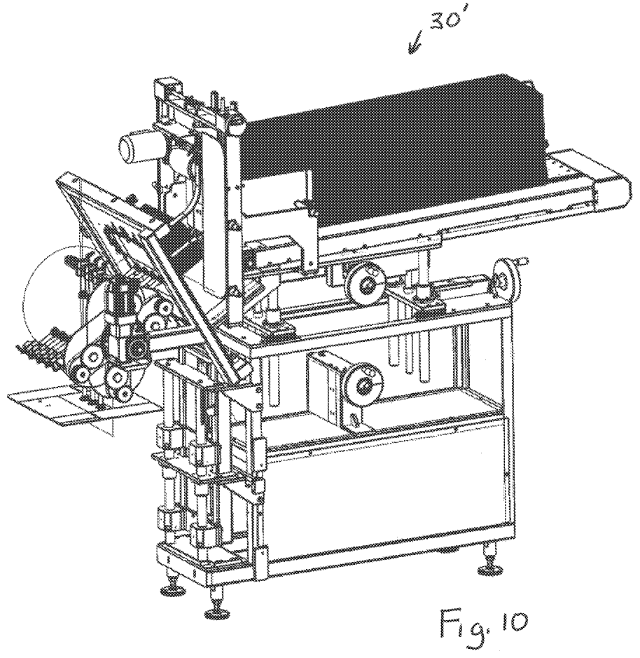

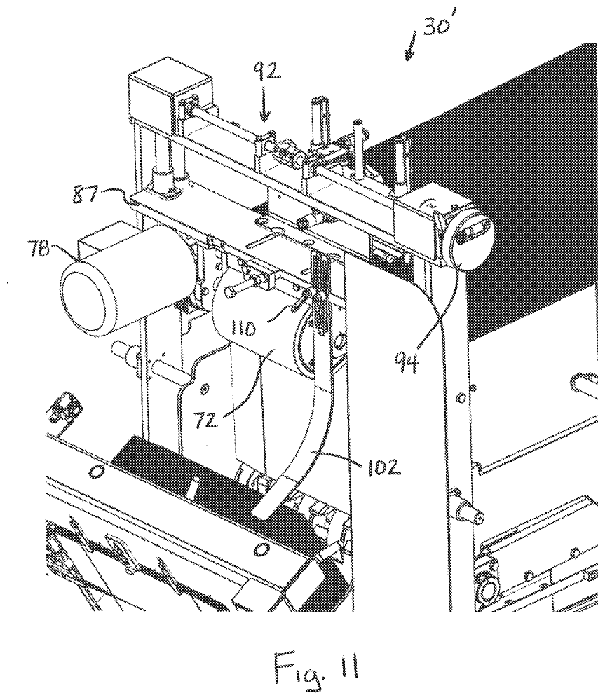

The gating mechanism 70 is adjustably mounted to enable a height of the gating mechanism, relative to a conveying surface 34a of the lateral conveyor 34, to be varied according to carton size (e.g., height that the cartons extend upward from the surface 34a). Here, the roller 72 and drive 78 are positioned on a movable mount 86 to enable a height of the gating mechanism to be varied according to carton size. The mount 86 is in the form of a plate 87 that is movable vertically along spaced apart adjustment rods 88 and spaced apart guide rods 90. The adjustment rods 88 can be rotated via an upper gearing and shaft system 92, which itself is rotatable via a handle 94 that rotates a flexible link 96 with an end gear 98. The adjustment rods 88 are configured to interact with sleeves 100, which are fixed to the plate 87, to effect raising or lowering of the plate 87, depending upon the direction of rotation of the adjustment rods. For example, interacting threads may be provided on the guide rods 88 and the sleeves 100 for this purpose. In the alternative embodiment of an assembly 30′ shown in FIGS. 10 and 11, where like numbers represent like parts, the handle 94 is connected directly to the shaft system 92, eliminating the need for the link 96 and end gear 98.

The feed path of the guide chute includes spaced apart upper guides 102, each of which has an upper portion 104 connected for movement with the movable mount plate 87. Thus, adjustment of the vertical position of the gating mechanism to properly match carton size also results in simultaneous adjustment of the vertical position of the guides 102 to properly match carton size. In addition, the upper portions 104 of the guides 102 include slots 106 that enable the positions of the upper guides relative to the movable mount plate to also be adjusted separately, if needed (e.g. by loosening bolts 108, shifting the guides, and then retightening the bolts 108). In the alternative embodiment of the assembly 30′ shown in FIGS. 10 and 11, only a single guide 102 is provided, and adjustment of the guide position relative to the movable mounting plate 87 is achieved using kipp handles 110, instead of the bolts mentioned 108 above.

The described powered carton magazine advantageously provides a two stage system, where the first stage is formed by the lateral conveyor and the second stage is formed by the feed chute, and with a controlled flow of cartons from the first stage to the second stage so as to prevent excessive backpressure in the second stage.

It is to be clearly understood that the above description is intended by way of illustration and example only, is not intended to be taken by way of limitation, and that changes and modifications are possible. For example, other gating mechanism configurations are possible, such as a movable or stationary stop against which the upright cartons are pushed by the conveyor, in combination with one or more movable pushers that engage a top edge of the last carton to selectively push the last carton down into the picking station chute. In another variation, the gating mechanism could comprise a vacuum grip system that selectively grips the leading face of the last carton along the conveyor and moved the carton downward. In still another variation, the gating mechanism could comprise a lower grip mechanism that selectively grabs the bottom edge of the last carton and pulls the last carton down into the picking station chute.

What is claimed is:

1. A powered carton magazine assembly, comprising:
a lateral conveyor configured for conveying a plurality of upright folded/flat cartons in a feed direction, the lateral conveyor having a load end and an outfeed end;
a picking station at the outfeed end of the lateral conveyor, the picking station including a picking station chute and a frame at a lower portion of the picking station chute, wherein the frame defines an opening through which cartons can be individually picked; and
a gating mechanism at the outfeed end of the lateral conveyor for selective delivery of cartons from the lateral conveyor down into the picking station chute.

2. The assembly of claim 1, further comprising:
a gating mechanism control system including at least one sensor for detecting cartons in the picking station chute and a controller associated with the sensor and the gating mechanism, the controller configured to control the gating mechanism based at least in part upon an output from the sensor.

3. The assembly of claim 2, wherein the gating mechanism control is configured to control the gating mechanism so as to prevent a level of cartons in the picking station chute from exceeding a set high level.

4. The assembly of claim 3, wherein the gating mechanism control is configured to control the gating mechanism so as to prevent the level of cartons in the picking station chute from falling below a set low level.

5. The assembly of claim 1, wherein the gating mechanism is adjustably mounted to enable a height of the gating mechanism, relative to a conveying surface of the lateral conveyor, to be varied according to carton size.

6. The assembly of claim 1, wherein the gating mechanism comprises a rotatable roller configured such that rotation of the roller in a first direction will move a carton blank at the outfeed end of the lateral conveyor down into the picking station chute.

7. The assembly of claim 6, wherein the gating mechanism further comprises a roller drive for selectively rotating the roller.

8. The assembly of claim 7, wherein the roller and the roller drive are mounted to an end frame segment of the lateral conveyor and a position of the roller and the roller drive are adjustable along a height of the end frame segment.

9. A powered carton magazine assembly, comprising:
a lateral conveyor configured for conveying a plurality of upright folded/flat cartons in a feed direction, the lateral conveyor having a load end and an outfeed end;
a picking station at the outfeed end of the lateral conveyor, the picking station including a downwardly angled feed path and a frame at a lower portion of the feed path, wherein the frame defines an opening through which cartons can be picked; and
a gating mechanism at the outfeed end of the lateral conveyor for selectively controlling delivery of cartons from the lateral conveyor into the feed path.

10. The assembly of claim 9, wherein the gating mechanism comprises a rotatable roller configured such that rotation of the roller in a first direction will move a carton blank at the outfeed end of the lateral conveyor into feed path.

11. The assembly of claim 10, further comprising:
a roller control system including at least one sensor for detecting carton level in the feed path, a drive linked to effect rotation of the roller, and a controller configured to control the drive based at least in part upon carton level in the feed path.

12. The assembly of claim 11, wherein the controller is configured to control the drive so as to prevent a level of cartons in the picking station chute from exceeding a set high level.

13. The assembly of claim 12, wherein the controller is configured to control the drive so as to prevent the level of cartons in the picking station chute from falling below a set low level.

14. The assembly of claim 9, wherein the roller is positioned on a movable mount to enable a height of the gating mechanism to be varied according to carton size.

15. The assembly of claim 14, wherein the feed path includes at least one upper guide, wherein the upper guide is connected for movement with the movable mount.

16. The assembly of claim 15, wherein a position of the upper guide relative to the movable mount is also adjustable.

17. A powered carton magazine assembly, comprising:
a lateral conveyor configured for conveying a plurality of upright folded/flat cartons in a feed direction, the lateral conveyor having a load end and an outfeed end;
a picking station at the outfeed end of the lateral conveyor, the picking station including a downwardly angled feed path and a pick location at a lower portion of the feed path; and
a gating mechanism at the outfeed end of the lateral conveyor for selectively controlling delivery of cartons from the lateral conveyor into the feed path.

18. The assembly of claim 17, wherein the gating mechanism comprises a rotatable roller configured such that rotation of the roller in a first direction will move a carton blank at the outfeed end of the lateral conveyor into feed path.

19. The assembly of claim 18, further comprising:
a roller control system including at least one sensor for detecting carton level in the feed path, a drive linked to effect rotation of the roller, and a controller configured to control the drive based at least in part upon carton level in the feed path.

20. The assembly of claim 19, wherein the controller is configured to control the drive so as to prevent a level of cartons in the picking station chute from exceeding a set high level.
